(19) United States
(12) Patent Application Publication
(10) Pub. No.: US 2023/0014104 A1
(43) Pub. Date: Jan. 19, 2023

(54) DEVICES AND METHODS FOR GENERATING RESONANCE EXCITATION FOR AN ION MANIPULATION APPARATUS

(71) Applicant: Shanghai Polaris Biology Co., Ltd., Shanghai (CN)

(72) Inventors: Yupeng Cheng, Shanghai (CN); Siyu Wu, Shanghai (CN)

(21) Appl. No.: 17/878,830

(22) Filed: Aug. 1, 2022

Related U.S. Application Data
(63) Continuation of application No. PCT/CN2020/074426, filed on Feb. 6, 2020.

(51) Int. Cl. H01J 49/42

(52) U.S. Cl. CPC H01J 49/4225

(57) ABSTRACT

Devices and methods of generating resonance excitation for an ion manipulation apparatus are provided. The ion manipulation apparatus can be operated as an ion filtration apparatus used with particle mass spectrometry system. The devices and methods can be capable of generating a resonance excitation to effect an ion filtration in a multipole apparatus. The resonance excitation is generated by mixing a radio frequency signal with a plurality of alternative current voltage signals having different frequencies. The resonance excitation can be added to at least one electrode of the multipole apparatus. The generation of mixed alternative current voltage signal is performed in a time domain, therefore no time-consuming inverse Fourier transform procedure is needed, which significantly improves an analysis speed and a throughput of the particle mass spectrometry system.

### CROSS-REFERENCE

This application is a continuation application of International Application No. PCT/CN2020/074426, filed Feb. 6, 2020, the content of which application is incorporated herein by reference.

### FIELD OF THE INVENTION

The present disclosure relates generally to ion manipulation apparatus used with a particle mass spectrometry system. More particularly, the present disclosure relates to devices and methods for generating resonance excitation for an ion manipulation apparatus, which is capable of filtering out multiple types of ions simultaneously in the ion manipulation apparatus by resonance excitation.

### BACKGROUND OF THE INVENTION

Mass spectrometry-based techniques have been developed, which greatly improves the performance of particle analysis. Mass spectrometry has many advantages such as high sensitivity, fast analysis speed, multi-parameter measurement and high specificity. A multipole mass analyzer based on dynamic electric field is widely used for mass spectrometry.

A multipole mass analyzer can perform various ion manipulation, such as mass separation, on ions. A quadrupolar mass analyzer can be an example of multipole mass analyzer. The quadrupolar field theory can be the foundation of quadrupole mass analyzer and quadrupole ion trap. A generation of ideal quadrupole field requires two pairs of hyperboloid electrodes to which proper radio frequency (RF) and direct current (DC) voltages are applied. The physical size, voltage parameters and the mass of ions determine the stable conditions of ions in the quadrupolar field, which means the so-called a value and q value for a certain ion should locate in the stability region according to the quadrupolar field theory. Only ions that meet the stable conditions maintain a stable and periodic motion in the quadrupolar field, so that these ions can pass through the quadrupole mass analyzer. Any ions that do not meet the stable conditions escape from the quadrupole mass analyzer or hit the electrodes, due to the fact that their oscillating amplitudes get larger and larger.

Motion of ions in the quadrupole mass analyzer can be divided into two components. One motion component is an axial component, where a direction of motion being identical to an extension direction of the quadrupole mass analyzer. The other motion component is a radial component, where a direction of motion is the application direction of quadrupolar field. In theory, except for the two axial ends of the quadrupole, the two components of ion motion are independent and decoupled, so they can be studied independently. A mass separation in the quadrupole mass analyzer is mainly performed by controlling the radial motion component. The radial ion motion is more complicated and consists of a set of components with different frequencies, which is called the secular frequencies. For a specific quadrupole device and working parameters, the secular frequencies are characteristics of the mass to charge ratio of ions. Therefore, it is possible to cause a specific group of ions to resonate in the radial direction by applying an alternating current (AC) voltage having a frequency which is identical to the secular frequency of that specific group of ions. When a resonance amplitude of the ions is large enough, the ions will hit the electrodes or escape from the quadrupole device. The frequency of AC voltage can be scanned to filter ions having different mass sequentially. In addition, a set of AC voltages, each having a distinct frequency, can be mixed and applied to the electrodes of the quadrupole mass analyzer, in order to filter multiple types of ions simultaneously or even permit only a small mass range to pass through the quadrupole mass analyzer.

Quadrupole ion trap mass analyzers, which are also based on quadrupolar field theory for mass separation of ions, are also widely used. The working principle of a quadrupole ion trap mass analyzer is slightly different from that of a quadrupole mass analyzer. Usually, only RF voltages are applied to the electrodes of the quadrupole ion trap mass analyzer, meaning that the a value for all ions is equal to zero and only q value is considered; therefore, ions in a wider mass range can be trapped in the quadrupole ion trap. In order to achieve mass separation of ions, an AC voltage having a certain frequency can be additionally applied. A frequency of AC voltage is identical to the secular frequency of ions having a certain mass to charge ratio in the quadrupole ion trap, therefore it causes a resonance excitation of the ions. When an amplitude of the resonance excitation is large enough, the ions will be ejected and captured by a detector outside the quadrupole ion trap. Since the secular frequencies of ions are also related with their q values, a mass scanning of quadrupole ion trap can be achieved by scanning either the frequency of AC voltage or the frequency/amplitude of RF voltage. In addition, multiple AC voltages having different frequencies can be applied simultaneously, such that multiple types of ions can be excited or ejected simultaneously.

### SUMMARY OF THE INVENTION

Ions having different masses can enter into the quadrupole mass analyzer for analysis. The RF and DC voltages applied to the electrodes can be scanned, so that the ions can pass through the quadrupole in a certain order of mass to charge ratio. However, since the amplitude of the RF and DC voltages is directly proportional to the mass to charge ratio of ions, a high RF voltage, typically up to several kilovolts, is required for high mass ions. This not only increases the risk of electrical discharge, but also brings challenges to the design of power supplies.

Stored waveform inverse Fourier transform (SWIFT) technology can be used with the quadrupole ion trap for ion excitation and isolation. The SWIFT waveform comprises various frequency components, therefore it can be used to effect an excitation of multiple ions simultaneously. The basic principle is that, a spectrum is first generated in the frequency domain according to the secular frequencies of ions to be excited, and then the voltage waveform is obtained in the time domain via inverse Fourier transform. However, since the SWIFT method requires a time-consuming inverse Fourier transform procedure, the analysis speed and throughput of the quadrupole ion trap are adversely limited.

A need exists for devices and methods capable of filtering multiple types of ions simultaneously in a multipole mass analyzer. With the devices and methods for generating resonance excitation for a multipole mass analyzer provided in the disclosure, multiple types of ions, each type having a specific mass to charge ratio, can be filtered from the multipole mass analyzer simultaneously by application of a mixed alternative current voltage. In addition, a generation of the mixed alternative current voltage is directly performed in the time domain, avoiding the time-consuming inverse Fourier transform procedure. Therefore, the analysis speed and throughput of the multipole mass analyzer can be significantly improved.

Disclosed herein is a device for generating resonance excitation for an ion manipulation apparatus having a plurality of electrodes. The device can comprise a radio frequency (RF) power supply coupled to the ion manipulation apparatus, the RF power supply being configured to generate a RF voltage signal, and a mixed alternating current (AC) power supply coupled to the ion manipulation apparatus, the AC power supply being configured to generate a mixed AC voltage signal by superimposing a plurality of AC voltage signals. The mixed AC voltage signal and the RF voltage signal are combined, and the combined voltage signal is applied to at least one electrode of the ion manipulation apparatus.

A frequency, an amplitude and/or a phase of the RF voltage signal can be selected to confine ions within the ion manipulation apparatus. A frequency, an amplitude and/or a phase of the mixed

AC voltage signal can be selected for resonance excitation of multiple ions within the ion manipulation apparatus.

In an embodiment, the mixed AC power supply can comprise a signal adding device. The signal adding device can be configured to superimpose the plurality of alternative current signals each having a specific frequency, amplitude and/or phase to generate the mixed AC voltage signal. The plurality of alternative current signals can be generated in a time domain. In some instances, the plurality of alternative current signals and the mixed AC voltage signal can be digital signals, and the signal adding device can be a digital signal adding device. The signal adding device can comprise a digital-to-analog converter configured to convert the digital mixed AC voltage signal into an analog mixed AC voltage signal. In some instances, the plurality of alternative current signals and the mixed

AC voltage signal can be analog signals, and the signal adding device can be an analog signal adding device. In an embodiment, the mixed AC power supply can comprise an amplifier coupled to the signal adding device. The amplifier can be configured to amplify the mixed AC voltage signal. tm 31 In an embodiment, the ion manipulation apparatus is an ion filtration apparatus. The number of the plurality of AC voltage signals can be determined based at least on the number of ion types to be filtered by the ion filtration apparatus. At least one AC voltage signal can be generated to filter a certain ion type. In some instances, a frequency of the at least one AC voltage signal for filtering out the certain ion type can be determined by secular frequencies of the certain ion type. For instance, the frequency of the at least one AC voltage signal for filtering out the certain ion type can be substantially identical with a fundamental frequency within the secular frequencies of the certain ion type to cause a resonance excitation of the certain ion type.

The ion manipulation apparatus can be a multipole apparatus. The plurality of electrodes can comprise a plurality of poles. In some instances, the multipole apparatus can comprise a hexapole. The hexapole can comprise a segmented hexapole. In some instances, the multipole apparatus can comprise an octupole. The octupole can comprise a segmented octupole. In some instances, the multipole apparatus can comprise a quadrupole. The quadrupole can comprises a segmented quadrupole. The quadrupole can comprise four poles which extend substantially parallel to each other. The four poles can comprise a first set and a second set. In an embodiment, the RF voltage signal can be applied to each pole in the first set, a minus RF voltage signal plus the mixed AC voltage signal can be applied to a first pole in the second set, and a minus RF voltage signal minus the mixed AC voltage signal can be applied to a second pole in the second set. In an embodiment, the RF voltage signal plus the mixed AC voltage signal can be applied to each pole in the first set, and a minus RF voltage signal minus the mixed AC voltage signal can be applied to each pole in the second set. In an embodiment, the RF voltage signal can be applied to each pole in the first set, a minus RF voltage signal can be applied to a first pole in the second set, and a minus RF voltage signal plus the mixed AC voltage signal can be applied to a second pole in the second set. In another embodiment, the RF voltage signal plus the mixed AC voltage signal can be applied to each pole in the first set, a minus RF voltage signal can be applied to a first pole in the second set, and a minus RF voltage signal plus the mixed AC voltage signal can be applied to a second pole in the second set.

Further disclosed herein is a method for generating resonance excitation for an ion manipulation apparatus having a plurality of electrodes. The method can comprise generating a radio frequency (RF) voltage signal with a RF power supply, the RF power supply being coupled to the ion manipulation apparatus; generating a mixed alternating current (AC) voltage signal by superimposing a plurality of AC voltage signals with a mixed AC power supply, the mixed AC power supply being coupled to the ion manipulation apparatus; and combining the mixed AC voltage signal and the RF voltage signal to generate a combined voltage signal. The combined voltage signal can to be applied to at least one electrode of the ion manipulation apparatus.

Further disclosed herein is a method for providing a device for generating resonance excitation for an ion manipulation apparatus having a plurality of electrodes. The method can comprise providing a radio frequency (RF) power supply, the RF power supply being coupled to the ion manipulation apparatus and configured to generate a RF voltage signal; providing a mixed alternating current (AC) power supply, the mixed AC power supply being coupled to the ion manipulation apparatus and configured to generate a mixed AC voltage signal by superimposing a plurality of AC voltage signals; and combining the mixed AC voltage signal and the RF voltage signal and applying the combined voltage signal to at least one electrode of the ion manipulation apparatus.

Also disclosed herein is a device for generating resonance excitation for an ion manipulation apparatus having a plurality of electrodes. The device can comprise a radio frequency (RF) power supply coupled to the ion manipulation apparatus, the RF power supply being configured to generate a RF voltage signal; and an alternating current (AC) power supply coupled to the ion manipulation apparatus, the AC power supply being configured to generate an AC voltage signal. The AC voltage signal and the RF voltage signal can be combined to generate at least a first combination of the RF and AC voltage signals and a second combination of the RF and AC voltage signals different from the first combination. The first combination of the RF and AC voltage signals can be applied to at least one electrode of the ion manipulation apparatus, and the second combination of the RF and AC voltage signals can be applied to at least one other electrode of the ion manipulation apparatus.

A frequency, an amplitude and/or a phase of the RF voltage signal can be selected to confine ions within the ion manipulation apparatus. A frequency, an amplitude and/or a phase of the AC voltage signal can be selected for resonance excitation of ions of a certain ion type within the ion manipulation apparatus. The ions of the certain ion type can have a substantially same mass-to-charge ratio.

In an embodiment, the AC power supply can be a mixed AC power supply comprising a signal adding device. The signal adding device can be configured to superimpose a plurality of alternative current signals each having a specific frequency, amplitude and/or phase to generate a mixed AC voltage signal. The plurality of alternative current signals can be generated in a time domain. In some instances, the plurality of alternative current signals and the mixed AC voltage signal can be digital signals, and the signal adding device can be a digital signal adding device. The signal adding device can comprise a digital-to-analog converter configured to convert the digital mixed AC voltage signal into an analog mixed AC voltage signal. In some instances, the plurality of alternative current signals and the mixed AC voltage signal can be analog signals, and the signal adding device can be an analog signal adding device. The mixed AC power supply can comprise an amplifier coupled to the signal adding device. The amplifier can be configured to amplify the mixed AC voltage signal.

In an embodiment, the ion manipulation apparatus can be an ion filtration apparatus. The AC voltage signal can be generated to filter the ions of the certain ion type. A frequency of the AC voltage signal can be determined by secular frequencies of the certain ion type. In some instances, the frequency of the AC voltage signal can be substantially identical with a fundamental frequency within the secular frequencies of the certain ion type to cause resonance excitation of the certain ion type.

The ion manipulation apparatus can be a multipole apparatus. The plurality of electrodes can comprise a plurality of poles. The multipole apparatus can comprise a quadrupole. The quadrupole can comprise a segmented quadrupole. The multipole apparatus can comprise a hexapole. The hexapole can comprise a segmented hexapole. The multipole apparatus can comprise an octupole. The octupole can comprise a segmented octupole.

Further disclosed herein is a method for generating resonance excitation for an ion manipulation apparatus having a plurality of electrodes. The method can comprise generating a radio frequency (RF) voltage signal with a RF power supply, the RF power supply being coupled to the ion manipulation apparatus; generating an alternating current (AC) voltage signal with a AC power supply, the AC power supply being coupled to the ion manipulation apparatus; and combining the AC voltage signal and the RF voltage signal to generate at least a first combination of the RF and AC voltage signals and a second combination of the RF and AC voltage signals different from the first combination. The first combination of the RF and AC voltage signals can be applied to at least one electrode of the ion manipulation apparatus, and the second combination of the RF and AC voltage signals can be applied to at least one other electrode of the ion manipulation apparatus.

Further disclosed herein is a method for providing a device for generating resonance excitation for an ion manipulation apparatus having a plurality of electrodes. The method can comprise providing a radio frequency (RF) power supply, the RF power supply being coupled to the ion manipulation apparatus and configured to generate a RF voltage signal; providing an alternating current (AC) power supply, the AC power supply being coupled to the ion manipulation apparatus and configured to generate a AC voltage signal; and combining the AC voltage signal and the RF voltage signal to generate at least a first combination of the RF and AC voltage signals and a second combination of the RF and AC voltage signals different from the first combination. The first combination of the RF and AC voltage signals can be applied to at least one electrode of the ion manipulation apparatus, and the second combination of the RF and AC voltage signals can be applied to at least one other electrode of the ion manipulation apparatus.

Additional aspects and advantages of the present disclosure will become readily apparent to those skilled in this art from the following detailed description, wherein only exemplary embodiments of the present disclosure are shown and described, simply by way of illustration of the best mode contemplated for carrying out the present disclosure. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows a block diagram of an exemplary ion manipulation apparatus coupled with a device for generating resonance excitation in accordance with some embodiments of the disclosure;

FIG. 2 is a schematic showing a generation of a mixed alternative current voltage signal by a signal adding device in accordance with some embodiments of the disclosure;

FIG. 3 is a schematic showing ion excitation in a quadrupole apparatus to which ion resonance excitation is applied in accordance with some embodiments of the disclosure;

FIG. 4A to FIG. 4D are schematics showing voltage application schemes of the mixed alternative current voltage signal and the radio frequency voltage signal to electrodes of a quadrupole apparatus in accordance with some embodiments of the disclosure; FIG. 4A showing a first voltage application scheme to the quadrupole apparatus, FIG. 4B showing a second voltage application scheme to the quadrupole apparatus, FIG. 4C showing a third voltage application scheme to the quadrupole apparatus, and FIG. 4D showing a fourth voltage application scheme to the quadrupole apparatus;

FIG. 5A to FIG. 5D show an ion trajectory under various voltage application schemes of the mixed alternative current voltage signal in accordance with some embodiments of the disclosure;

FIG. 5A showing a scheme where no alternative current voltage is applied, FIG. 5B showing a scheme where a first alternative current voltage is applied, FIG. 5C showing a scheme where a second alternative current voltage is applied, FIG. 5D showing a scheme where both the first and second alternative current voltages are applied;

FIG. 6A to FIG. 6F show exemplary waveforms of a radio frequency voltage signal, various alternative current voltage signals and the radio frequency voltage signal superimposed with one or more alternative current voltage signals in accordance with some embodiments of the disclosure; FIG. 6A showing a waveform of the radio frequency voltage signal, FIG. 6B showing a waveform of a first alternative current voltage signal, FIG. 6C showing a waveform of a second alternative current voltage signal, FIG. 6D showing a waveform of the radio frequency voltage signal superimposed with the first alternative current voltage signal, FIG. 6E showing a waveform of the radio frequency voltage signal superimposed with the second alternative current voltage signal, and

FIG. 6F showing a waveform of the radio frequency voltage signal superimposed with the first and second alternative current voltage signals;

FIG. 7 is a schematic showing a voltage application scheme of the mixed alternative current voltage signal to electrodes of a hexapole apparatus in accordance with some embodiments of the disclosure;

FIG. 8 is a schematic showing a voltage application scheme of the mixed alternative current voltage signal to electrodes of an octupole apparatus in accordance with some embodiments of the disclosure; and

FIG. 9 shows an example of a computer system, provide din accordance with embodiments of the invention.

### DETAILED DESCRIPTION OF THE INVENTION

While preferable embodiments of the invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

Devices and methods of generating resonance excitation for an ion manipulation apparatus are provided. The ion manipulation apparatus can be operated as an ion filtration apparatus used with particle mass spectrometry system. The devices and methods can be capable of generating a resonance excitation to effect an ion filtration in a multipole apparatus. The resonance excitation is generated by mixing a plurality of alternative current voltage signals having different frequencies with a radio frequency signal. The resonance excitation can be added to at least one electrode of the multipole apparatus.

A frequency of each one alternative current voltage signal can be determined based on the secular frequencies of the ions or group of ions to be filtered out from the multipole apparatus. The ions or group of ions can have a specific mass to charge ratio and specific secular frequencies. Therefore, an arbitrary group of ions having substantially identical mass to charge ratio can be filtered out by adding a corresponding alternative current voltage signal to the multipole apparatus. The generation of mixed alternative current voltage signal is performed in time domain, therefore no time-consuming inverse Fourier transform procedure is needed, which significantly improves a generation speed of the mixed alternative current voltage signal, an analysis speed and a throughput of the particle mass spectrometry system.

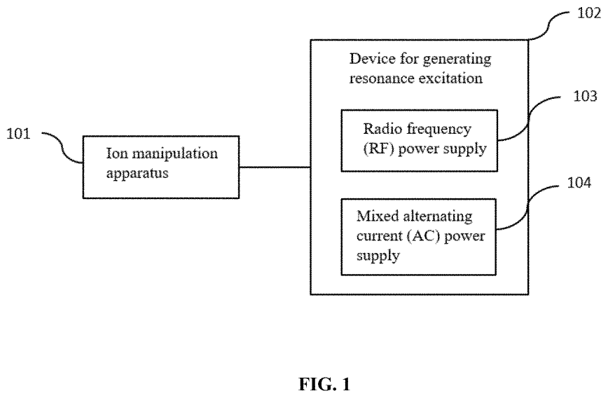

FIG. 1 shows a block diagram of an exemplary ion manipulation apparatus 101 coupled with a device for generating resonance excitation 102 in accordance with some embodiments of the disclosure. The ion manipulation apparatus 101 can comprise a multipole device. The multipole device can be a device having a plurality of poles. The poles can be arranged substantially parallel to each other. In some instances, the multipole device can comprise, for example, a quadrupole device, a hexapole device or an octupole device. The multipole device may include two or more poles. The multipole device may include an even number of poles. The poles, when arranged, may have collectively form corners of a polygon or a circumference of a circle. An interior region may be defined between the poles. The poles can be provided as cylindrical rod. A cross-section of the pole can be circular or elliptical. The cross-section of the pole may have any other shape, such as triangle, square, hexagon, rectangle, or any other shape. The interior surface of the poles can approach a perfect hyperbola. The multipole device can comprise a segmented multipole device where the poles are divided into a plurality of segments. The segmented multipole device can comprise, for example, a segmented quadrupole device, a segmented hexapole device and a segmented octupole device. A pole may be formed from a single integral piece or from multiple pieces that may be joined, connected, contacting, or adjacent to one another.

The device for generating resonance excitation 102 can comprise a radio frequency (RF) power supply 103 configured to generate a RF voltage signal and a mixed alternative current (AC) power supply 104 configured to generate a mixed AC voltage signal. The RF power supply can be configured to generate a RF voltage signal. A frequency, amplitude and/or phase of the RF voltage signal of the RF voltage signal can be configurable. The AC power supply can be configured to generate one ore more AC voltage signals. A frequency, amplitude and/or phase of each AC voltage signal can be configurable. In some instances, a mixed AC voltage signal can be generated by superimposing a plurality of AC voltage signals generated from the AC power supply. For examples, multiple AC voltages having one or more differing characteristics (e.g., one or more differing frequencies, amplitudes, and/or phases) may be added together. In other instances, the AC voltage signal can be a single AC voltage signal generated from the AC power supply without a superimposing operation. An RF voltage signals and an AC voltage signals may be coupled together by the device. The AC voltage signal may be a mixed voltage signal comprising an AC voltage signal generated by superimposing a plurality of AC voltage signals. Any description herein of a mixed AC voltage signal may also apply to a single AC voltage signal. For instance, any description herein of an RF voltage and mixed AC voltage signals coupled together may also apply to an RF voltage and single AC voltage signal coupled together. The RF voltage signal and the mixed AC voltage signal can be coupled together by the device for generating resonance excitation. The coupled signal can then be applied to at least one electrode of the multipole device. The RF voltage signal can be configured to confine ions within an interior space of the multipole device. For instance, a frequency, an amplitude and/or a phase of the RF voltage signal can be selected to limit a movement of ions within the interior space of the ion manipulation apparatus. The mixed AC voltage signal can be configured to induce a resonance excitation of ions within the interior space of the ion manipulation apparatus. The number of AC voltage signals in the mixed AC voltage signal can correspond the number of ions to be manipulated.

In some embodiments, the ion manipulation apparatus can be an ion filtration apparatus. The mixed AC voltage signal can be applied to filter at least one specific ion type from among the ions entering into the ion filtration apparatus. The number of the plurality of AC voltage signals, which are to be mixed at the mixed AC power supply can be determined based at least on the number of ion types to be filtered by the ion filtration apparatus. At least one AC voltage signal from among the plurality of AC voltage signals can be generated and applied to filter a specific ion type. In some instances, the number of AC voltage signals in the mixed AC voltage signal can correspond to the number of ions to be filtered. In an embodiment, the number of AC voltage signals in the mixed AC voltage signal can be identical to the number of ions to be filtered. A specific ion type can comprise a plurality of ions having substantially identical mass to charge ratio or substantially identical mass.

A frequency of the at least one AC voltage signal for filtering out the specific ion type can be determined by secular frequencies of the specific ion type. In some embodiments, the frequency of the at least one AC voltage signal can be substantially identical with a fundamental frequency within the secular frequencies of the specific ion type to cause a resonance excitation of the specific ion type.

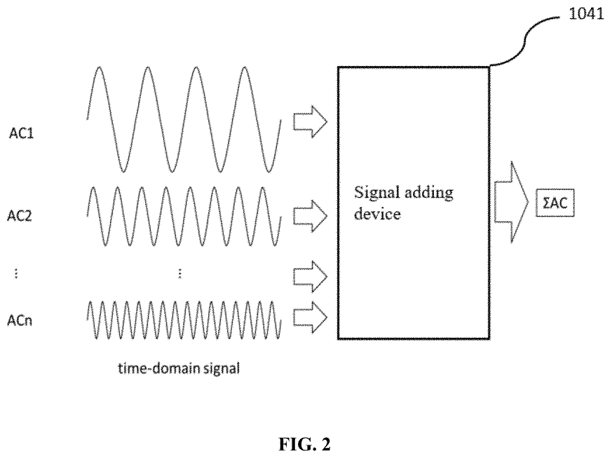

FIG. 2 is a schematic showing a generation of the mixed alternative current (AC) voltage signal in accordance with some embodiments of the disclosure. The mixed AC power supply 104 can comprise a signal adding device 1041 which is configured to superimpose a plurality of alternative current (AC) signals AC1, AC2 . . . ACn, each having a specific frequency, amplitude and/or phase to generate the mixed AC voltage signal. The mixed AC voltage signal can be applied to the multipole device to filter at least one ion type from among the ions existing within the multipole device.

The number of the plurality of AC voltage signals can be determined based on the number of ion types to be filtered. At least one AC voltage signal can be required to filter one specific ion type. A frequency of each AC voltage signal from among the plurality of AC voltage signals can be determined by the secular frequencies of the ion type to be filtered. For instance, a frequency, an amplitude and/or a phase of the voltage signal AC1 can be selected to cause a radial movement of a first ion type larger than a radial size of the multipole device, such that ions of the first ion type can escape from the interior space of multipole device or strike the electrodes of the multipole device.

The plurality of AC voltage signals can then be superimposed at the signal adding device 1041 to generate the mixed AC voltage signal ΣAC. The signal adding device can be provided with an amplifier which is configured to amplify the mixed AC voltage signal. An ion filtration efficiency can be affected by the dwell time of ions in the multipole device. The dwell time of ions can be related with a number of parameters including an axial velocity of ions, a length of the multipole device and a gas pressure. In some instances, in order to improve the ion filtration efficiency, a sufficiently high AC voltage can be required. Meanwhile, due to a difference of the q value and the pseudopotential well depth among ions, the optimal AC voltage can be different.

The plurality of AC signals can be generated in the time domain. In some instances, the plurality of AC signals can each be a digital signal. Correspondingly, the signal adding device can be a digital signal adding device, and the mixed AC voltage signal can be a digital signal. A digital-to-analog converter, which is configured to convert the digital mixed AC voltage signal into an analog mixed AC voltage signal, can be provided with the signal adding device. In an example, the plurality of digital AC signals can each be a digitally stored code, and the digital signal adding device can be a digitally encoded computer program stored at a computer-readable medium. In some instances, the plurality of AC signals can each be an analog signal. Correspondingly, the signal adding device can be an analog signal adding device, and the mixed AC voltage signal can be an analog signal.

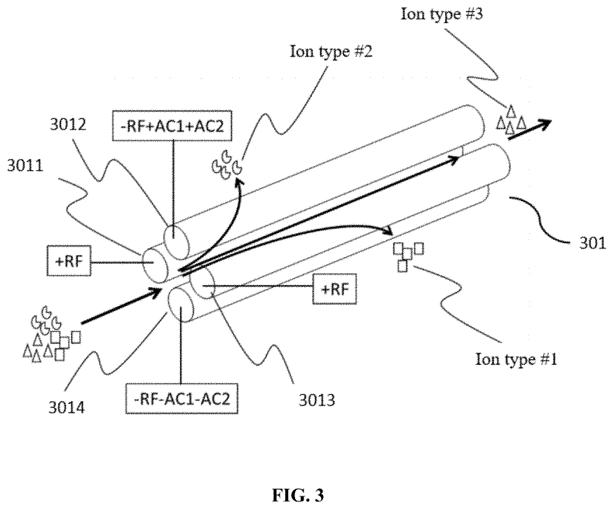

FIG. 3 is a schematic showing ion excitation in a quadrupole apparatus 301 to which ion resonance excitation is applied in accordance with some embodiments of the disclosure. The quadrupole apparatus 301 can be operated as an ion filtration apparatus. The quadrupole apparatus can comprise four poles which are substantially provided in a rod-like configuration. The poles can extend substantially parallel with each other in an axial direction to define an interior space into which a plurality of ion groups are ejected. The poles can comprise a first set and a second set, each set comprising two poles which are diagonally positioned. For instance, the first set of poles can comprise poles 3011 and 3013, and the second set of poles can comprise poles 3012 and 3014. The poles can function as electrodes to which a voltage is applied.

As shown in FIG. 3, when mixed ions (e.g., ion type #1, ion type #2 and ion type #3) entering into the interior space of the quadrupole apparatus, due to a radial confinement of the RF voltage signals applied to the electrodes of the quadrupole apparatus, the ions can oscillate periodically in the radial direction. In order to filter out a specific ion type consisting of or comprising ions having a specific mass to charge ratio or a specific mass, at least one AC voltage signal having a corresponding frequency, amplitude and/or phase can be generated. As discussed elsewhere in the disclosure, the frequency of the at least one AC voltage signal for filtering out the specific ion type can be substantially identical with a fundamental frequency within the secular frequencies of the specific ion type. A plurality AC voltage signals each having corresponding frequency and amplitude (e.g., AC1 and AC2) can be generated in order to filter out ions of a plurality of ion types (e.g., ion type #1 and ion type #2).

The plurality AC voltage signals can be mixed to generate the mixed AC voltage signal. The mixed AC voltage signal can then be superimposed on the RF voltage to generate a combined voltage signal. The combined voltage signal can be applied to at least one pole of the quadrupole apparatus. In the example shown in FIG. 3, the RF voltage signal can be applied to each pole 3011 and 3013 in the first set, a minus RF voltage signal plus the mixed AC voltage signal (e.g., −RF+AC1+AC2) can be applied to a first pole 3012 in the second set, and a minus RF voltage signal minus the mixed AC voltage signal (e.g., −RF−AC1−AC2) can be applied to a second pole 3014 in the second set. Since the frequencies of the generated AC voltage signals are identical with the secular frequencies of the ions to be filtered (e.g., ion tyoe #1 and ion type #2), the applied AC voltage signals can cause a resonance excitation of ions to be filtered. When a resonance amplitude of those ions in a radial direction exceeds a physical size of the interior space of the quadrupole apparatus, the ions can strike onto or escape from the poles of the quadrupole apparatus. Meanwhile, ions with other mass to charge ratios (e.g., ion type #3) may not be affected by the mixed AC voltage signal and can pass through the quadrupole apparatus.

As compared with traditional quadrupole mass filter, the ion manipulation apparatus disclosed in the disclosure does not need an application of quadrupolar DC voltages. Moreover, ions to be filtered are not limited by the mass sequence. The ions having arbitrary mass to charge ratio, mass or mass combination within a specific mass range can be filtered simultaneously by applying proper mixed AC voltage signal. In addition, the ion resonance excitation caused by application of mixed AC voltage signal can also be similarly realized with a hexapole device or an octupole device. Traditionally, however, since an ion motion in the radial direction of hexapole or octupole is complicate, hexapole or octupole devices are precluded as ion filtration devices.

In the devices and methods provided in the disclosure, a multipole DC voltage, which is required in a traditional multipole device, is not applied. However, a bias DC voltage can still be needed in the disclosed devices. The bias DC voltage can be applied to rods of a multipole device with identical amplitude and polarity. An application of the bias DC voltage can provide proper axial field at the entrance and exit ends of the multipole device while ions flowing in and out.

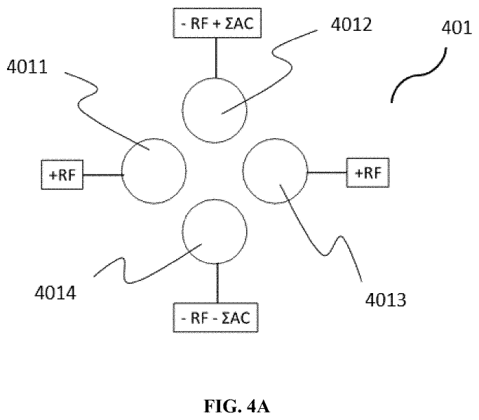

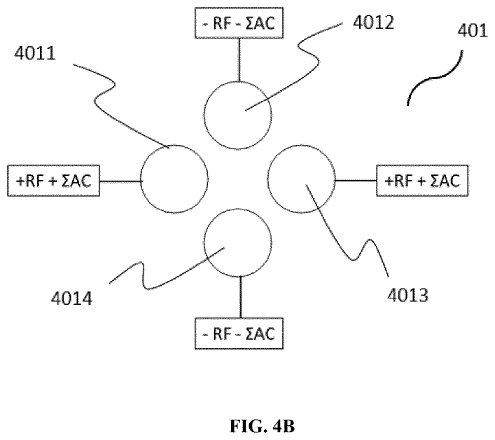

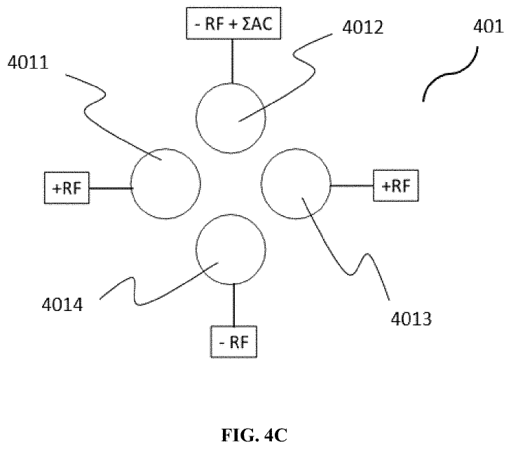

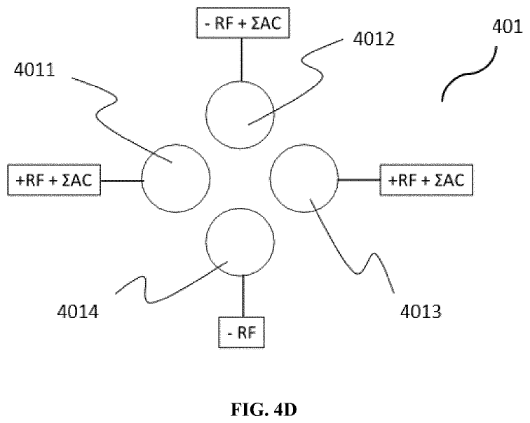

FIG. 4A to FIG. 4D are schematics showing various voltage application schemes of the mixed alternative current voltage signal and the radio frequency voltage signal to electrodes of a quadrupole apparatus in accordance with some embodiments of the disclosure. The quadrupole apparatus 401 can be operated as an ion filtration apparatus. The quadrupole apparatus can comprise four poles 4011-4014 with a first set 4011 and 4013 and a second set 4012 and 4014, each set comprising two poles which are diagonally positioned. A mixed alternative current (AC) voltage signal ΣAC can be generated by adding a plurality of AC voltage signals together. Each of the plurality of AC voltage signal can be generated to filter a specific ion type from the quadrupole apparatus. The RF signal can be applied to confine ions within the interior space of the quadrupole apparatus. Though exemplary embodiments are described with reference to quadrupole apparatus, the ion resonance excitation caused by application of mixed AC voltage signal can also be realized with other multipole apparatus such as a hexapole apparatus or an octupole apparatus.

In a first voltage application scheme shown in FIG. 4A, the RF voltage signal can be applied to each pole 4011 and 4013 in the first set of poles in the quadrupole apparatus, a minus RF voltage signal plus the mixed AC voltage signal ΣAC (e.g., −RF+ΣAC) can be applied to a first pole 4012 in the second set, and a minus RF voltage signal minus the mixed AC voltage signal (e.g., −RF−ΣAC) can be applied to a second pole 4014 in the second set.

In a second voltage application scheme shown in FIG. 4B, the RF voltage signal plus the mixed AC voltage signal ΣAC (e.g., RF+ΣAC) can be applied to each pole 4011 and 4013 in the first set of poles in the quadrupole apparatus, a minus RF voltage signal minus the mixed AC voltage signal ΣAC (e.g., −RF−ΣAC) can be applied to each pole 4012 and 4014 in the second set.

In a third voltage application scheme shown in FIG. 4C, the RF voltage signal can be applied to each pole 4011 and 4013 in the first set of poles in the quadrupole apparatus, a minus RF voltage signal plus the mixed AC voltage signal ΣAC (e.g., −RF+ΣAC) can be applied to a first pole 4012 in the second set, and a minus RF voltage signal can be applied to a second pole 4014 in the second set.

In a fourth voltage application scheme shown in FIG. 4D, the RF voltage signal plus the mixed AC voltage signal ΣAC (e.g., RF+ΣAC) can be applied to each pole 4011 and 4013 in the first set of poles in the quadrupole apparatus, a minus RF voltage signal plus the mixed AC voltage signal ΣAC (e.g., −RF+ΣAC) can be applied to a first pole 4012 in the second set, and a minus RF voltage signal is applied to a second pole 4014 in the second set.

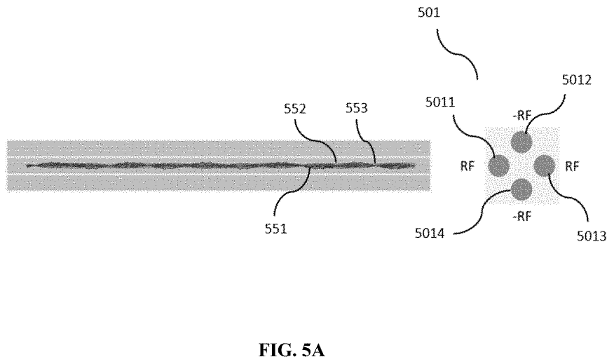

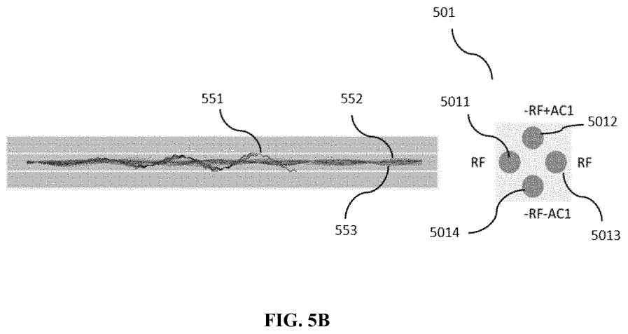

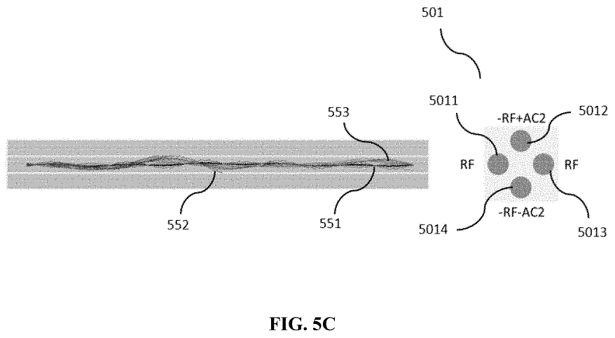

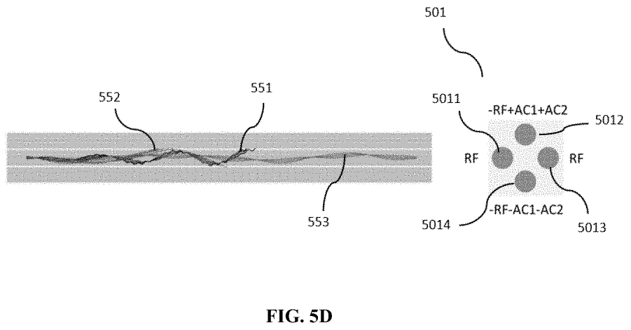

FIG. 5A to FIG. 5D show an ion trajectory under various voltage application schemes of the mixed alternative current voltage signal in accordance with some embodiments of the disclosure. The quadrupole apparatus 501 can comprise four poles with a first set 5011 and 5013 and a second set 5012 and 5014. The quadrupole apparatus can be operated as an ion filtration apparatus by applying appropriate voltage signals to the poles (e.g., electrodes). The examples of FIG. 5A to FIG. 5D show an ion stream containing ions in three ion types, which can comprise a first ion type 551, a second ion type 552, and a third ion type 553. Ions in the first to third ion types can have different mass to charge ratios or masses. In an exemplary example, ions in the first ion type can have a mass to charge ratio 40, ions in the second ion type can have a mass to charge ratio 80, and ions in the third ion type can have a mass to charge ratio 120.

In the example shown in FIG. 5A, only a RF voltage signal is applied to the electrodes while no alternative current voltage is applied. In an exemplary example, the RF voltage signal can have a frequency 2.5 MHz and a voltage 150 V_{0P} (i.e., pole to ground voltage). As shown in the waveform diagram, since no resonance excitation is caused to the ions, ions in all the three ion types 551-553 can pass through the quadrupole apparatus.

In the example shown in FIG. 5B, a first AC voltage signal AC1 can be applied to electrodes 5012 and 5014 in the second set. In an exemplary example, the first AC voltage signal AC1 can have a frequency 0.25 MHz and a voltage 2.5 V_{0P}. For instance, the RF voltage signal can be applied to each pole 5011 and 5013 in the first set of poles in the quadrupole apparatus, a minus RF voltage signal plus the first AC voltage signal AC1 (e.g., −RF+AC I) can be applied to a first pole 5012 in the second set, and a minus RF voltage signal minus the first AC voltage signal AC1 (e.g., −RF−AC1) can be applied to a second pole 5014 in the second set. As shown in the waveform diagram, ions in a first ion type 551 can experience a resonance excitation caused by the first AC voltage signal. The resonance excitation can have an amplitude equal to or larger than a radial dimension of the interior space of the quadrupole apparatus, such that ions in the first ion type either strike onto the electrode or escape from the electrode and are thus filtered out from the ion stream, and ions in the second and third ion types 552 and 553 pass through the quadrupole apparatus. An ion filtration efficiency can be substantially 100%.

In the example shown in FIG. 5C, a second AC voltage signal AC2 can be applied to electrodes 5012 and 5014 in the second set. In an exemplary example, the second AC voltage signal AC2 can have a frequency 70 KHz and a voltage 2.5 V_{0P}. For instance, the RF voltage signal can be applied to each pole 5011 and 5013 in the first set of poles in the quadrupole apparatus, a minus RF voltage signal plus the second AC voltage signal AC2 (e.g., −RF+AC2) can be applied to a first pole 5012 in the second set, and a minus RF voltage signal minus the second AC voltage signal AC2 (e.g., −RF−AC2) can be applied to a second pole 5014 in the second set. As shown in the waveform diagram, ions in the second ion type 552 can be subjected to a resonance excitation and filtered out from the ion stream, and ions in the first and third ion types 551 and 553 pass through the quadrupole apparatus.

In the example shown in FIG. 5D, a first AC voltage signal AC1 and a second AC voltage signal AC2 can be mixed and applied to electrodes 5012 and 5014 in the second set. For instance, the RF voltage signal can be applied to each pole 5011 and 5013 in the first set of poles in the quadrupole apparatus, a minus RF voltage signal plus the mixed AC voltage signal (e.g., −RF+AC1+AC2) can be applied to a first pole 5012 in the second set, and a minus RF voltage signal minus the mixed AC voltage signal (e.g., −RF−AC1−AC2) can be applied to a second pole 5014 in the second set. As shown in the waveform diagram, ions in the first ion type 551 and ions in the second ion type 552 can both be filtered out from the ion stream, leaving only ions in the third ion type 553 passing through the quadrupole apparatus.

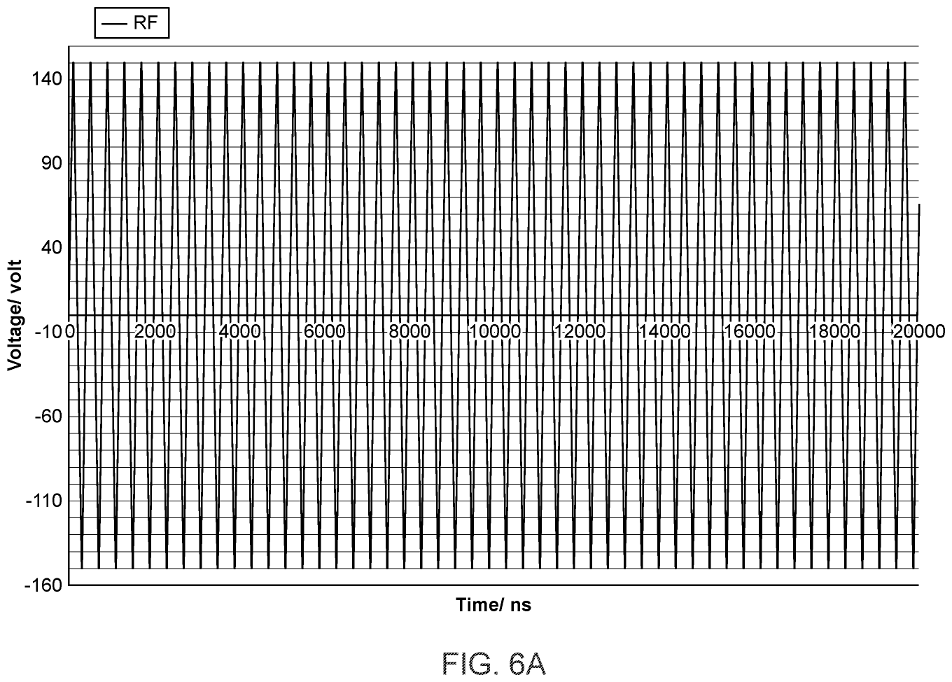

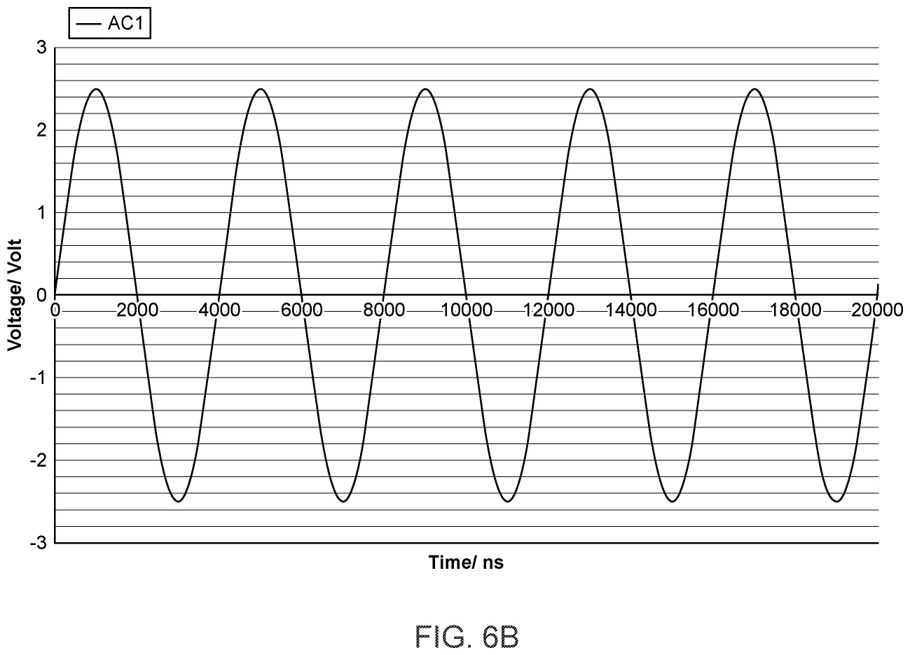

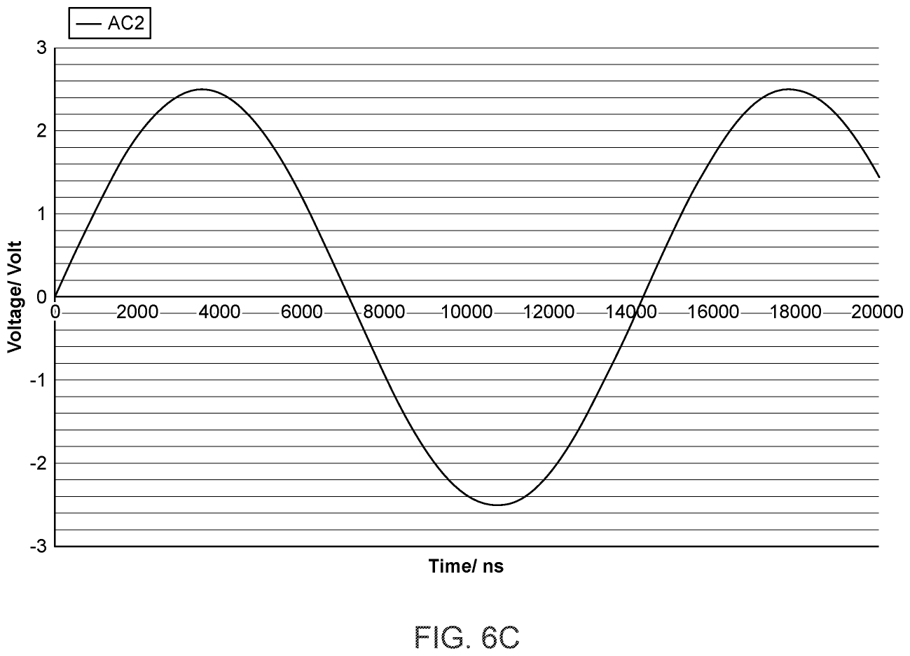

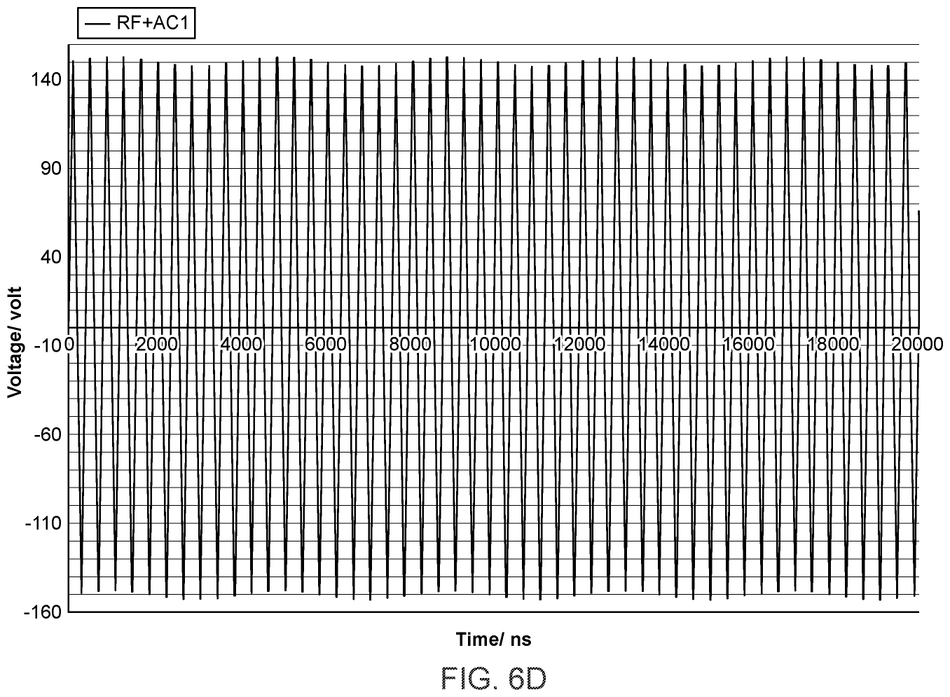

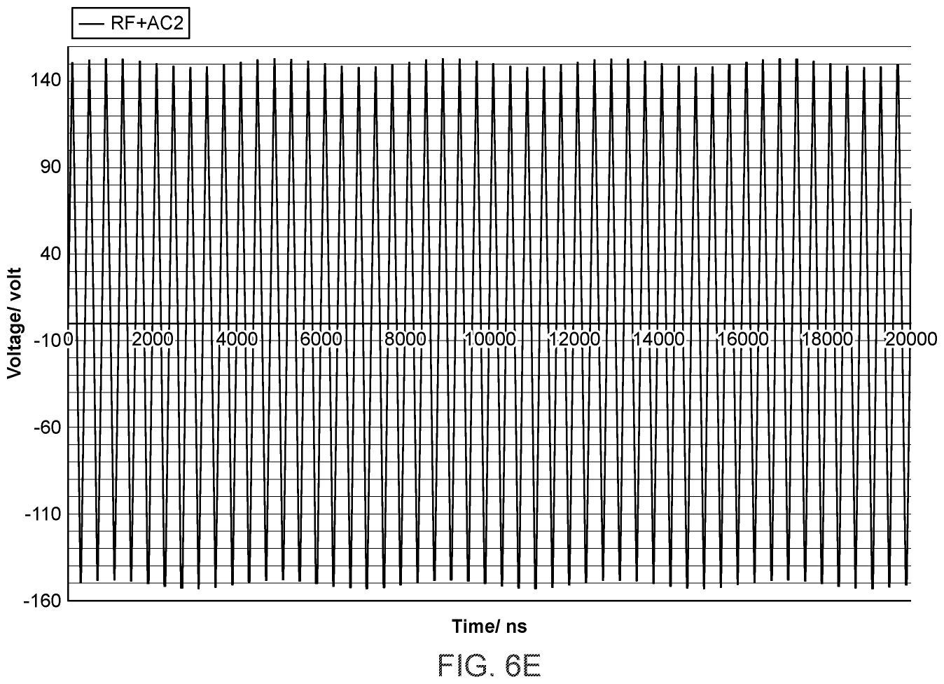

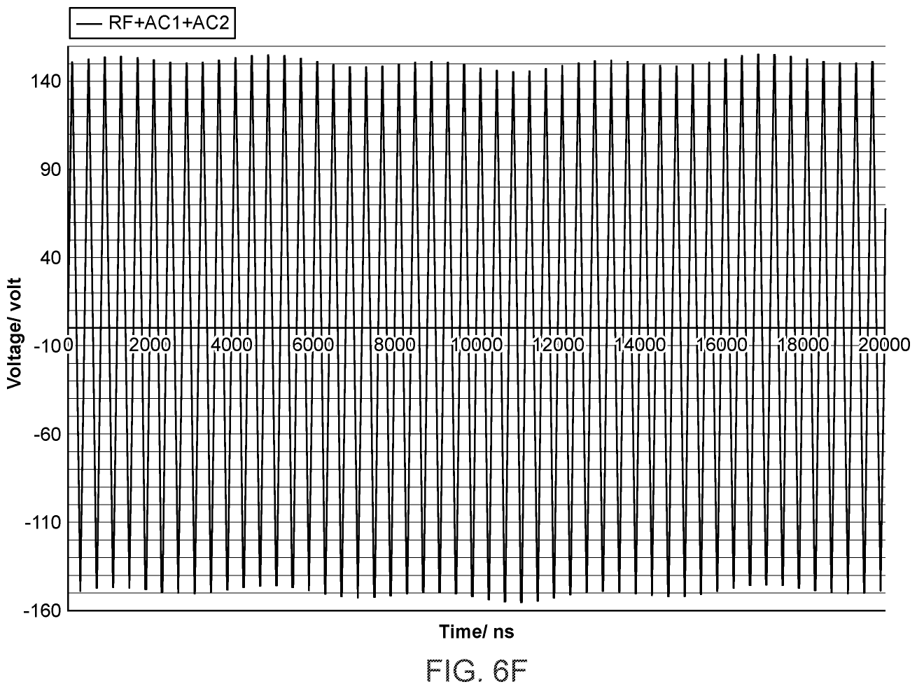

FIG. 6A to FIG. 6F show exemplary waveforms of a radio frequency voltage signal, various alternative current voltage signals and the radio frequency voltage signal superimposed with one or more alternative current voltage signals in accordance with some embodiments of the disclosure. FIG. 6A shows a waveform of the radio frequency voltage signal. In an example, the RF voltage signal can have a frequency 2.5 MHz and a voltage 150 V₀₋ₚ (i.e., pole to ground voltage). The RF voltage signal can be FIG. 6B shows a waveform of a first alternative current voltage signal. In an example, the first AC voltage signal AC1 can have a frequency 0.25 MHz and a voltage 2.5 V_{0P}, FIG. 6C shows a waveform of a second alternative current voltage signal. In an example, the second AC voltage signal AC2 can have a frequency 70 KHz and a voltage 2.5 V_{0P}.

As discussed in the disclosure, a single AC voltage signal can be applied to the multipole device to filter out ions in a corresponding ion type, and a mixed AC voltage signal containing a plurality of AC voltage signals can be applied to the multipole device to filter out ions in various ion types. FIG. 6D shows a waveform of the RF voltage signal of FIG. 6A superimposed with the first AC voltage signal of FIG. 6B. The superimposed voltage signal can be applied to at least one electrode of a multipole device to filter out ions in a corresponding first ion type from an ion stream, as shown in FIG. 5B. FIG. 6E shows a waveform of the RF voltage signal of FIG. 6A superimposed with the second AC voltage signal of FIG. 6C. The superimposed voltage signal can be applied to at least one electrode of a multipole device to filter out ions in a corresponding second ion type from an ion stream, as shown in FIG. 5C. FIG. 6F shows a waveform of the RF voltage signal superimposed with the first and second AC voltage signals. The superimposed voltage signal can be applied to at least one electrode of a multipole device to filter out ions in corresponding first and second ion types from an ion stream, as shown in FIG. 5D.

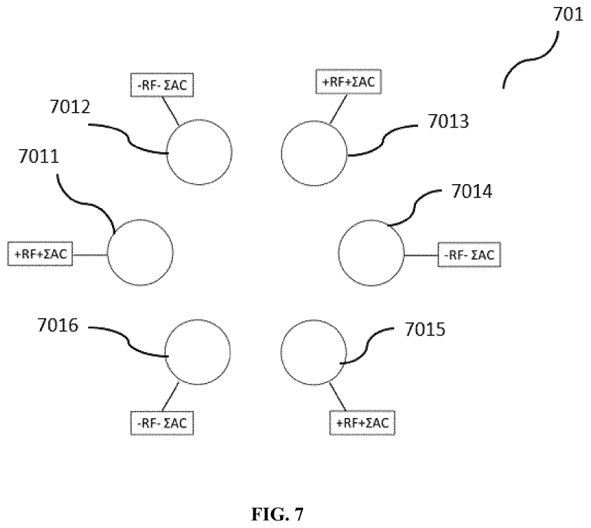

FIG. 7 is a schematic showing a voltage application scheme of single or mixed AC voltage signal to electrodes of a hexapole apparatus 701 in accordance with some embodiments of the disclosure. The hexapole apparatus can be operated as an ion filtration apparatus. The hexapole apparatus can comprise six poles 7011-7016. The poles can be provided as cylindrical rod. A cross-section of the pole can be circular. A mixed AC voltage signal ΣAC can be generated by adding a plurality of AC voltage signals together. Each of the plurality of AC voltage signal can be generated to filter a specific ion type from the hexapole apparatus. Optionally, a single AC voltage signal can be applied to filter out one certain ion type from the ion stream. The RF signal can be applied to confine ions within the interior space of the hexapole apparatus.

In an exemplary voltage application scheme shown in FIG. 7, a RF voltage signal plus the mixed AC voltage signal ΣAC (e.g., RF+ΣAC) can be applied to poles 7011, 7013 and 7015, and a minus RF voltage signal minus the mixed AC voltage signal (e.g., −RF−ΣAC) can be applied to poles 7012, 7014 and 7016.

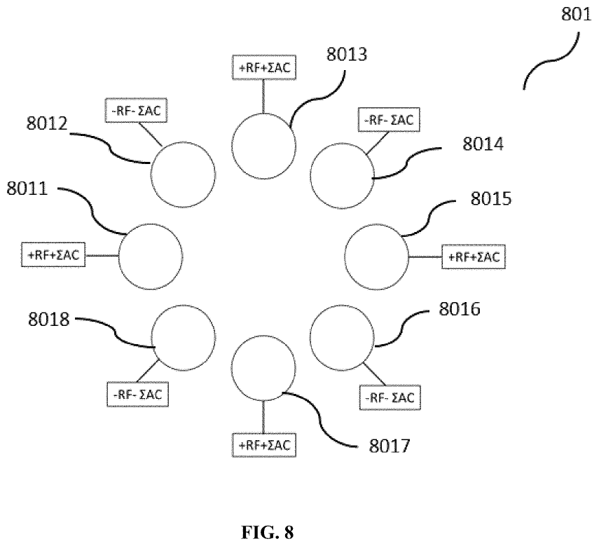

FIG. 8 is a schematic showing a voltage application scheme of single or mixed AC voltage signal to electrodes of an octupole apparatus 801 in accordance with some embodiments of the disclosure. The octupole apparatus can be operated as an ion filtration apparatus. The octupole apparatus can comprise eight poles 8011-8018. The poles can be provided as cylindrical rod. A cross-section of the pole can be circular. A mixed AC voltage signal ΣAC can be generated by adding a plurality of AC voltage signals together. Each of the plurality of AC voltage signal can be generated to filter a specific ion type from the octupole apparatus. Optionally, a single AC voltage signal can be applied to filter out one certain ion type from the ion stream. The RF signal can be applied to confine ions within the interior space of the octupole apparatus.

In an exemplary voltage application scheme shown in FIG. 8, a RF voltage signal plus the mixed AC voltage signal ΣAC (e.g., RF+ΣAC) can be applied to poles 8011, 8013, 8015 and 8017, and a minus RF voltage signal minus the mixed AC voltage signal (e.g., −RF−ΣAC) can be applied to poles 8012, 8014, 8016 and 8018.

With the exemplary embodiments described with reference to FIGS. 4A-AD, FIG. 7 and FIG. 8, it is clear that the number of poles in the multipole device is not limited to four, six or eight. A multipole device having arbitrary number of poles can be used with the invention disclosed in the disclosure. The mixed AC voltage signal, which can comprise one or more AC voltage signal components, can be combined with a RF voltage signal, and the combined voltage signal can be applied to at least one pole of the multipole device with various voltage application schemes. tM)81 In some embodiments, opposing poles may have the same RF values as one another. In some instances, opposing poles may have RF voltage signals coupled with opposite AC voltage signals (e.g., +RF+ΣAC, −RF+ΣAC, or −RF−ΣAC). In some instances, opposing poles may have the RF signal or inversed RF signal (e.g., RF, or −RF). In some other embodiments, opposing poles may have different voltage values.

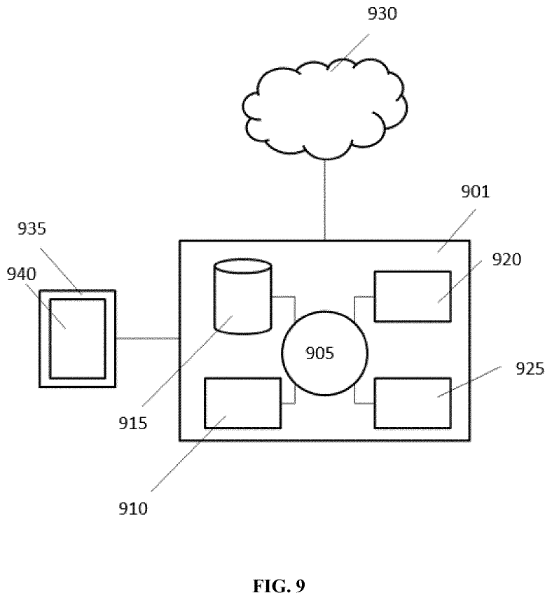

The present disclosure provides a computer system that is programmed to implement methods and systems of the disclosure. FIG. 9 shows a computer system 901 that is programmed or otherwise configured to implement a signal processing device as described above. The computer system 901 can regulate various aspects of the present disclosure, such as, for example, controlling ion gating components and rendering graphical user interfaces and the other functions as described elsewhere herein. The computer system 901 can be an electronic device of a user or a computer system that is remotely located with respect to the electronic device. The electronic device can optionally be a mobile electronic device.

The computer system 901 includes a central processing unit (CPU, also “processor” and “computer processor” herein) 909, which can be a single core or multi core processor, or a plurality of processors for parallel processing. The computer system 901 also includes memory or memory location 910 (e.g., random-access memory, read-only memory, flash memory), electronic storage unit 915 (e.g., hard disk), communication interface 920 (e.g., network adapter) for communicating with one or more other systems, and peripheral devices 925, such as cache, other memory, data storage and/or electronic display adapters. The memory 910, storage unit 915, interface 920 and peripheral devices 925 are in communication with the CPU 909 through a communication bus (solid lines), such as a motherboard. The storage unit 915 can be a data storage unit (or data repository) for storing data. The computer system 901 can be operatively coupled to a computer network (“network”) 930 with the aid of the communication interface 920. The network 930 can be the Internet, an internet and/or extranet, or an intranet and/or extranet that is in communication with the Internet.

The network 930 in some cases is a telecommunication and/or data network. The network 930 can include one or more computer servers, which can enable distributed computing, such as cloud computing. For example, one or more computer servers may enable cloud computing over the network 930 (“the cloud”) to perform various aspects of analysis, calculation, and generation of the present disclosure, such as, for example, capturing a configuration of one or more experimental environments; performing usage analyses of products (e.g., applications); and providing outputs of statistics of projects. Such cloud computing may be provided by cloud computing platforms such as, for example, Amazon Web Services (AWS), Microsoft Azure, Google Cloud Platform, and IBM cloud. The network 930, in some cases with the aid of the computer system 901, can implement a peer-to-peer network, which may enable devices coupled to the computer system 901 to behave as a client or a server.

The CPU 909 can execute a sequence of machine-readable instructions, which can be embodied in a program or software. The instructions may be stored in a memory location, such as the memory 910. The instructions can be directed to the CPU 909, which can subsequently program or otherwise configure the CPU 909 to implement methods of the present disclosure. Examples of operations performed by the CPU 909 can include fetch, decode, execute, and writeback.

The CPU 909 can be part of a circuit, such as an integrated circuit. One or more other components of the system 901 can be included in the circuit. In some cases, the circuit is an application specific integrated circuit (ASIC).

The storage unit 915 can store files, such as drivers, libraries and saved programs. The storage unit 915 can store user data, e.g., user preferences and user programs. The computer system 901 in some cases can include one or more additional data storage units that are external to the computer system 901, such as located on a remote server that is in communication with the computer system 901 through an intranet or the Internet.

The computer system 901 can communicate with one or more remote computer systems through the network 930. For instance, the computer system 901 can communicate with a remote computer system of a user (e.g., a user of an experimental environment). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 901 via the network 930.

Methods as described herein can be implemented by way of machine (e.g., computer processor) executable code stored on an electronic storage location of the computer system 901, such as, for example, on the memory 910 or electronic storage unit 915. The machine executable or machine readable code can be provided in the form of software. During use, the code can be executed by the processor 909. In some cases, the code can be retrieved from the storage unit 915 and stored on the memory 910 for ready access by the processor 909. In some situations, the electronic storage unit 915 can be precluded, and machine-executable instructions are stored on memory 910.

The code can be pre-compiled and configured for use with a machine having a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 901, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 901 can include or be in communication with an electronic display 1235 that comprises a user interface (UI) 940 for providing, for example, the various components (e.g., lab, launch pad, control center, knowledge center, etc) of the model management system. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 909. The algorithm can, for example, generate instructions to operate one or more component of a sample transport system.

It should be understood from the foregoing that, while particular implementations have been illustrated and described, various modifications can be made thereto and are contemplated herein. It is also not intended that the invention be limited by the specific examples provided within the specification. While the invention has been described with reference to the disclosure, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents.

1. A device for generating resonance excitation for an ion manipulation apparatus having a plurality of electrodes, said device comprising:
a radio frequency (RF) power supply coupled to the ion manipulation apparatus, said RF power supply being configured to generate a RF voltage signal; and
a mixed alternating current (AC) power supply coupled to the ion manipulation apparatus, said AC power supply being configured to generate a mixed AC voltage signal by superimposing a plurality of AC voltage signals,
wherein the mixed AC voltage signal and the RF voltage signal are combined, and the combined voltage signal is applied to at least one electrode of the ion manipulation apparatus.

2. The device of claim 1, wherein a frequency, an amplitude and/or a phase of the RF voltage signal are selected to confine ions within the ion manipulation apparatus.

3. The device of claim 1, wherein a frequency, an amplitude and/or a phase of the mixed AC voltage signal are selected for resonance excitation of multiple ions within the ion manipulation apparatus.

4. The device of claim 1, wherein the mixed AC power supply comprises a signal adding device, the signal adding device being configured to superimpose the plurality of alternative current signals each having a specific frequency, amplitude and/or phase to generate the mixed AC voltage signal.

5. (canceled)

6. The device of claim 4, wherein the plurality of alternative current signals and the mixed AC voltage signal are digital signals, and wherein the signal adding device is a digital signal adding device.

7-9. (canceled)

10. The device of claim 1, wherein the ion manipulation apparatus is an ion filtration apparatus.

11. The device of claim 10, wherein the number of the plurality of AC voltage signals is determined based at least on the number of ion types to be filtered by the ion filtration apparatus.

12-14. (canceled)

15. The device of claim 1, wherein the ion manipulation apparatus is a multipole apparatus.

16. (canceled)

17. The device of claim 15, wherein said multipole apparatus comprises a quadrupole.

18. (canceled)

19. The device of claim 17, wherein the quadrupole comprises four poles which extend substantially parallel to each other, said four poles comprising a first set and a second set, wherein the RF voltage signal is applied to each pole in the first set, a minus RF voltage signal plus the mixed AC voltage signal is applied to a first pole in the second set, and a minus RF voltage signal minus the mixed AC voltage signal is applied to a second pole in the second set.

20. The device of claim 17, wherein the quadrupole comprises four poles which extend substantially parallel to each other, said four poles comprising a first set and a second set, wherein the RF voltage signal plus the mixed AC voltage signal is applied to each pole in the first set, a minus RF voltage signal minus the mixed AC voltage signal is applied to each pole in the second set.

21. The device of claim 17, wherein the quadrupole comprises four poles which extend substantially parallel to each other, said four poles comprising a first set and a second set, wherein the RF voltage signal is applied to each pole in the first set, a minus RF voltage signal is applied to a first pole in the second set, and a minus RF voltage signal plus the mixed AC voltage signal is applied to a second pole in the second set.

22. The device of claim 17, wherein the quadrupole comprises four poles which extend substantially parallel to each other, said four poles comprising a first set and a second set, wherein the RF voltage signal plus the mixed AC voltage signal is applied to each pole in the first set, a minus RF voltage signal is applied to a first pole in the second set, and a minus RF voltage signal plus the mixed AC voltage signal is applied to a second pole in the second set.

23-26. (canceled)

27. A method for generating resonance excitation for an ion manipulation apparatus having a plurality of electrodes, said method comprising:
generating a radio frequency (RF) voltage signal with a RF power supply, said RF power supply being coupled to the ion manipulation apparatus;
generating a mixed alternating current (AC) voltage signal by superimposing a plurality of AC voltage signals with a mixed AC power supply, said mixed AC power supply being coupled to the ion manipulation apparatus; and
combining the mixed AC voltage signal and the RF voltage signal to generate a combined voltage signal, wherein said combined voltage signal is to be applied to at least one electrode of the ion manipulation apparatus.

28-40. (canceled)

41. The method of claim 27, wherein the ion manipulation apparatus is a multipole apparatus.

42. (canceled)

43. The method of claim 41, wherein said multipole apparatus comprises a quadrupole.

44. (canceled)

45. The method of claim 43, wherein the quadrupole comprises four poles which extend substantially parallel to each other, said four poles comprising a first set and a second set, wherein the RF voltage signal is applied to each pole in the first set, a minus RF voltage signal plus the mixed AC voltage signal is applied to a first pole in the second set, and a minus RF voltage signal minus the mixed AC voltage signal is applied to a second pole in the second set.

46. The method of claim 43, wherein the quadrupole comprises four poles which extend substantially parallel to each other, said four poles comprising a first set and a second set, wherein the RF voltage signal plus the mixed AC voltage signal is applied to each pole in the first set, a minus RF voltage signal minus the mixed AC voltage signal is applied to each pole in the second set.

47. The method of claim 43, wherein the quadrupole comprises four poles which extend substantially parallel to each other, said four poles comprising a first set and a second set, wherein the RF voltage signal is applied to each pole in the first set, a minus RF voltage signal is applied to a first pole in the second set, and a minus RF voltage signal plus the mixed AC voltage signal is applied to a second pole in the second set.

48. The method of claim 43, wherein the quadrupole comprises four poles which extend substantially parallel to each other, said four poles comprising a first set and a second set, wherein the RF voltage signal plus the mixed AC voltage signal is applied to each pole in the first set, a minus RF voltage signal is applied to a first pole in the second set, and a minus RF voltage signal plus the mixed AC voltage signal is applied to a second pole in the second set.

49-144. (canceled)
